(19) United States
(12) Patent Application Publication
(10) Pub. No.: US 2015/0070133 A1
(43) Pub. Date: Mar. 12, 2015

(54) IDENTIFICATION SENSOR FOR GATE IDENTIFICATION OF A PERSON

(71) Applicant: KONINKLIJKE PHILIPS N.V., EINDHOVEN (NL)

(72) Inventors: Roel Peter Geert Cuppen, Venlo (NL); Ingrid Christina Maria Flinsenberg, Eindhoven (NL); Evert Jan Van Loenen, Waalre (NL)

(21) Appl. No.: 14/391,091

(22) PCT Filed: Apr. 2, 2013
(86) PCT No.: PCT/IB2013/052616

§ 371 Date: Oct. 7, 2014

Related U.S. Application Data
(60) Provisional application No. 61/623,143, filed on Apr. 12, 2012.

(51) Int. Cl. G08C 17/02

(52) U.S. Cl. CPC G08C 17/02; G08C 2201/91
USPC 340/5.61

(57) ABSTRACT

The invention relates to an identification sensor (100) which is configured with two passage sensors (101, 102) and with an ID receiver (103). The ID receiver is configured to receive wirelessly transmitted radio frequency signals from a personal transmitter 111. The radio frequency signal is an ID signal which contains ID information which can be used for identifying the person carrying the personal transmitter (111), e.g. by retrieving further ID information form a database (112). Passage signals generated by the two passage sensors (101, 102) are compared in order to determine the motion direction of the user relative to the sensors. An output signal containing information about the ID information and the motion direction is generated. The output signal can be used for controlling e.g. ambient light in a patient room to satisfy working conditions for a doctor who enters the room and to adjust light to create a suitable atmosphere for the patient when the doctor leaves the room.

### FIELD OF THE INVENTION

The invention relates to a gate sensor, particularly to a gate sensor for identification detection of persons passing the gate.

### BACKGROUND OF THE INVENTION

Special ambient atmospheres may be created in patient rooms in a hospital in order to create a relaxing atmosphere. Such ambient atmospheres can be created by ambient systems capable of creating a special lighting of the room, presenting relaxing video or images or for example sounds or music. A relaxing atmosphere is important for the patient's well-being and may contribute to the healing process for the patient.

However, whereas an optimal ambient atmosphere may be created for optimizing the patient's well-being, this atmosphere may not be suitable in situations where a doctor visits the patient, when cleaning personnel has to clean the room or when family visits the patient. Thus, it may be a problem that the ambient atmosphere is inappropriate in some situations, particularly in situations where people other than the patient enter into the room.

Accordingly, there is a need to be able to adapt the ambient atmosphere in the patient room to different situations, e.g. to adapt the ambient atmosphere in dependence of different activities or events.

CN201262758 describes an open-typed gate control system with automatic radio frequency identification and comprises identification cards that are possessed by passing people, at least one infrared sensor and at least two readers that provide automatic radio frequency identification and are respectively arranged inside a passing doorframe and a passing door. The open-typed gate control system with automatic radio frequency identification provides multilevel security mechanism, thus effectively preventing the problems that passing people randomly borrow the identification card from others, do not carry the identification card according to provisions, are followed by multiple people and let illegal people enter the door, and the like, raises the management level of security regions, guarantees both the personal freedom and the passing security, and consequently the open-typed gate control system with automatic radio frequency identification can be widely applied into multiple fields such as gate control, finance, physical distribution, communication, etc.

The inventor of the present invention has appreciated that an improved gate sensor for identification detection is of benefit, and has in consequence devised the present invention.

### SUMMARY OF THE INVENTION

It would be advantageous to achieve improvements within the field of gate sensors for identification detection. In general, the invention preferably seeks to provide a gate sensor which can be used together with ambient systems to better adapt the ambient atmosphere in a room or other environment in dependence of a person either entering or leaving the room. In particular, it may be seen as an object of the present invention to provide a method that solves the above mentioned problems of ambient systems which may create atmospheres which are inappropriate in some situations, or other problems, of the prior art.

To better address one or more of these concerns, in a first aspect of the invention an identification sensor for gate identification of a person is presented that comprises:

a first passage detector for generating a first passage signal in response to passage of the person at a first location associated with the gate,

a second passage detector for generating a second passage signal in response to passage of the person at a second location associated with the gate,

wherein the identification sensor is configured to detect the order of generation of the first and second passage signals, and wherein the identification sensor is further configured to generate an output signal containing information relating to the order of generation of the first and second passage signals.

In this text, a first or second location associated with the gate may mean a location in close proximity of the gate such as a location near the gate. For example, a first location may be a location at one point in the gate or in front of the gate; and a second location may be a location at another point in the gate or behind the gate. A gate may be a door and the first and second locations may be locations at both sides of the door. A gate could also be a corridor, a passage or other building structure wherein the first and second locations are suitably arranged in order to enable detection of the moving direction of the person.

The output signal which contains information relating to the order of generation of the first and second passages signals can be used as input to an ambient atmosphere controller. Thereby, the ambient atmosphere controller is capable of adapting the ambient atmosphere in dependence of whether a person enters or leaves a room.

The identification sensor is suited for use with ambient atmosphere controllers for controlling atmospheres in a hospital or other caregiving environments. However, the identification sensor may also be used in other environments such as office environments for controlling ambient atmospheres or other purposes such as security control. Thus, in a hospital environment, the output signal advantageously be able to control an ambience controller e.g. to change a light setting of a light installation so that e.g. when a doctor enters the light intensity is increased for providing suitable working conditions for the doctors, and when the doctor leaves the light is changed back into a relaxing light atmosphere.

In an embodiment the identification sensor further comprises an ID receiver for receiving a wirelessly transmitted ID signal from an associated wearable ID transmitter, wherein the ID signal contains information relating to the identity of the person wearing the wearable ID transmitter. The information contained in the ID signal may be an arbitrary ID number which relate to the identity of the person wearing the ID transmitter via a lookup table or database entries, or the information may be an ID number directly associated with the person wearing the ID transmitter.

In an embodiment the identification sensor is furthermore configured to generate an output signal containing information relating to the ID signal received by an ID receiver. Accordingly, the identification sensor may be configured to generate an output signal containing information relating both to the order of generation of the first and second passage signals and the ID signal so that the output signal both contains information relating both to the direction of movement and information relating to the identity of the person wearing the wearable ID transmitter.

Thus, according to this embodiment, the output signal may advantageously be able to control an ambience controller so that the ambient atmosphere can be adapted in dependence of both the identity of the person and the direction of movement of the person. Accordingly, different ambient atmospheres such as different light settings may be set for e.g. a nurse who enters and cleaning personnel who enters a room.

Even in a situation where a person who passes the passage sensors does not carry an ID transmitter, an output signal is generated which contains indicating that some person (but not who) enters or leaves a room, this information may be useful for an ambient atmosphere controller. For example, visitors in a hospital may not carry ID transmitters and, therefore, an output signal which does not contain ID information may indicate that the person is a visitor.

In an embodiment the identification sensor is configured to determine a signal strength of the wirelessly transmitted ID signal. Thereby, is may be possible to determine which of a plurality of ID transmitters was carried by a person passing the first or second identification sensor.

In a related embodiment the identification sensor is configured to determine the signal strength in dependence of the first or second passage signals. Advantageously, the generation of the first and second passage signals may be exploited so that the signal strength is only determined when it is relevant, e.g. when a person has passed the first passage sensor.

In an embodiment the identification sensor is configured to activate the ID receiver to receive ID signals in dependence of the first or second passage signals. Since the ID receiver may only need to receive the ID signal when a person has passed one of the passage sensors, the ID receiver may advantageously be activated or powered when a passage signal is generated. Similarly the ID receiver may be deactivated in dependence of the first or second passage signals, e.g. deactivated when a first and a second passage signal has been generated.

In an embodiment the identification sensor further comprises:

a light transmitter configured to transmit a light signal to the associated wearable ID transmitter, where the ID transmitter is configured with a light receiver for receiving the light signal and where the ID transmitter is further configured to transmit the ID signal in dependence of receipt of the light signal.

Since an ID transmitter will only transmit the ID signal when the ID transmitter senses the light signal, only ID transmitters near the light transmitter is activated to transmit an ID signal. Since the light from the light transmitter may be focused (e.g. the light transmitter may emits a narrow and collimated light beam), so that in practice only one ID transmitter can sense the light signal, generation of a faulty output signal due to receipt of an ID signal from an ID transmitter which was not carried by a person passing one of the passage sensors may be avoided.

In a related embodiment of the identification sensor, the light transmitter is furthermore configured to transmit a light signal comprising ID information, wherein the ID transmitter is furthermore configured to transmit the ID signal containing the ID information received and the ID information stored in the ID transmitter.

In a related embodiment the light signal from the light transmitter contains ID information, and the ID transmitter is further configured to transmit the ID signal containing the received ID information and ID information stored in the ID transmitter. Since the light transmitter is located near the passage sensors, the ID signal will contain location ID information, e.g. a room ID, related to the room that a person is about to enter or leave. This location related ID information can be utilized by an ambience atmosphere controller for selecting ambient settings which are set-able/available for a particular location/room.

In an embodiment the identification sensor is configured to activate the light transmitter to transmit the light signal to the wearable ID transmitter in dependence of the first or second passage signals. By activating or powering the light transmitter only when a passage signal is generated a reduction of power consumption and extended lifetime of the transmitter may be obtained.

In an embodiment the identification sensor is configured to transmit data relating to the ID signal to a database and to receive ID data from the database in response to the data transmitted to the database, and the identification sensor is configured to generate the output signal so that is contains information relating to the ID data received from the database. Advantageously, an external database or a database contained by the identification sensor may be used for converting ID data from the ID transmitter and/or ID data from the light transmitter into other ID data which is interpretable by the identification sensor and possibly an ambient atmosphere controller.

A second aspect of the invention relates to a room controller, wherein the controller comprises:

an ambient atmosphere controller for controlling the ambience of a room,

an identification sensor according to the first aspect, wherein the identification sensor is further configured to generate an output signal for the ambient atmosphere controller in response to receipt of the wirelessly transmitted ID data.

A third aspect of the invention relates to a method for identifying a person and determining motion direction of the person at a gate, comprising:

generating, by use of a first passage detector, a first passage signal in response to passage of the person at a first location of the gate,

generating, by use of a second passage detector, a second passage signal in response to passage of the person at a second location of the gate,

detecting the order of generation of the first and second passage signals, and

generating an output signal containing information relating to the order of generation of the first and second passage signals.

In summary the invention relates to an identification sensor which is configured with two passage sensors and with an ID receiver. The ID receiver is configured to receive wirelessly transmitted radio frequency signals from a personal transmitter. The radio frequency signal is an ID signal which contains ID information which can be used for identifying the person carrying the personal transmitter, e.g. by retrieving further ID information form a database. Passage signals generated by the two passage sensors are compared in order to determine the motion direction of the user relative to the sensors. An output signal containing information about the ID information and the motion direction is generated. The output signal can be used for controlling e.g. ambient light in a patient room to satisfy working conditions for a doctor who enters the room and to adjust light to create a suitable atmosphere for the patient when the doctor leaves the room.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 schematically illustrates a first gate identification sensor 100,

FIG. 2 schematically illustrates a second gate identification sensor 200,

FIG. 3 schematically illustrates, as a function of time, first and second passage signals 301, 302, an ID signal 303 generated by a transmitter 111, 211 carried by a person passing the first and second passage sensors 101, 102, and an ID signal 304 generated by a transmitter 111, 211 carried by a person which does not pass the first and second passage sensors 101, 102, and

FIG. 4 illustrates process steps 401-404 of an embodiment of the invention.

### DESCRIPTION OF EMBODIMENTS

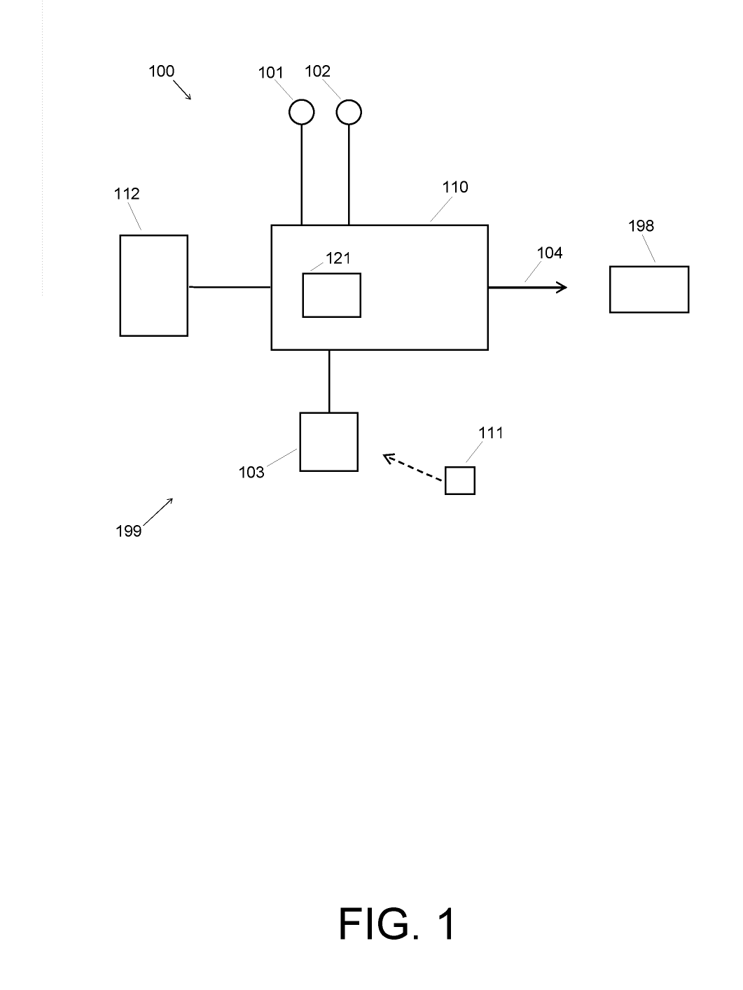

FIG. 1 schematically illustrates an identification sensor 100 for identifying motion direction and identification of a person going through a gate. The gate could be a passage, e.g. a door passage, leading to a room or other building structure. The identification of a person could be a unique personal ID, e.g. a personal number or identification category, e.g. the person belongs to a given group of nurses in a hospital. The motion direction could be one of two directions: either entering the room or leaving the room.

The identification sensor 100 comprises a first passage detector 101 which generates a first passage signal in response to passage of the person at a first location of the gate, and a second passage detector 102 which generates a second passage signal in response to passage of the person at a second location of the gate. The passage sensors could be infra-red light sensors capable of measuring changes in reflected or transmitted light in response to passage of a person. For example, the first passage sensor could be located on one side of a door leading to a room and the second sensor could be located on the opposite side of the door.

The identification sensor 100 further comprises an electronic ID receiver 103 for receiving a wirelessly transmitted ID signal from a wearable ID transmitter 111. The wearable ID transmitter may be an active RFID transmitter (also referred to as a tag) which stores ID data which is transmitted as a radio frequency signal. The ID transmitter may be powered by a battery or could also be powered by external sources, e.g. by electro-magnetic waves transmitted to a receiver of the ID transmitter 103 by an external radio-frequency/electro-magnetic transmitter (not shown). The ID receiver 103 comprises a receiver, e.g. an antenna, for receiving the ID signal. The ID data stored in the wearable ID transmitter 111 may be a unique ID of the user, a unique ID of the transmitter 111 or other ID data such as an ID specifying a group of personnel of a hospital.

The ID signal which may be a digital or analogue signal containing the ID data is received by a data processor 110 of the identification sensor 100. The identification sensor 100, e.g. the data processor 110, may transmit the ID signal or ID data derived from the ID signal, i.e. ID data relating to the ID signal, to a database 112. The database 112 looks up the received ID data in order to find other data such as the user's personal ID or the user's personnel category (e.g. category of nurses) and sends the looked up ID data back to the identification sensor 100.

The identification sensor 100 may be configured to detect the order of generation of the first and second passage signals. For example, if the first passage signal is generated before the second passage signal it may be concluded that a person enters a room or moves in a direction from the first passage sensor towards the second passage sensor.

The identification sensor 100 may further be configured to generate an output signal containing information relating to the ID signal and the order of generation of the first and second passage signals.

The output signal may be supplied via an output 104 of the identification sensor 100 to an ambient atmosphere controller 198. The ambient atmosphere controller 198 may be capable of controlling the light emitted by a light installation such as an ambient light system. Control of the ambience of a room, such as a patient ward, by changing e.g. light colors may have a relaxing effect on a patient and, thereby, improve the healing process and possibly reduce the recovery time. Also, control of the ambience of the room may be used for improving working conditions for personnel.

The ambient controller 198 is not limited for controlling ambient light settings, but may alternatively/additionally be configured for controlling an audio system for generating sounds or music, a video system for presenting images or video, an information system for generating various kinds of information for the user, systems for controlling blinds and devices which may have an effect on the ambient environment.

Since the output signal from the identification sensor 100 contains information relating both to the ID signal and the direction of motion of the person carrying the ID transmitter, the ambient atmosphere controller 198 can be instructed to control the room ambience in dependence of who is entering the room and leaving the room.

For example, if the ID signal of the ID transmitter defines that the person is a nurse and the order of the passage signals defines that the nurse enters the hospital room, the ambient light may be adjusted to a higher light intensity, e.g. locally at the location of the patient, to enable the nurse to e.g. take blood samples. When the nurse leaves the room as indicated in the output signal which contains information showing that the nurse (ID signal defines the nurse) leaves the room (defined by the order of the passage signals), the ambient light setting may be returned to the previous setting.

In general different persons or groups of personnel may have different preferences for the ambient setting. For example, a doctor or a group of doctors may prefer to have bright white light when entering, while a nurse or a group of nurses may prefer a less intrusive light setting.

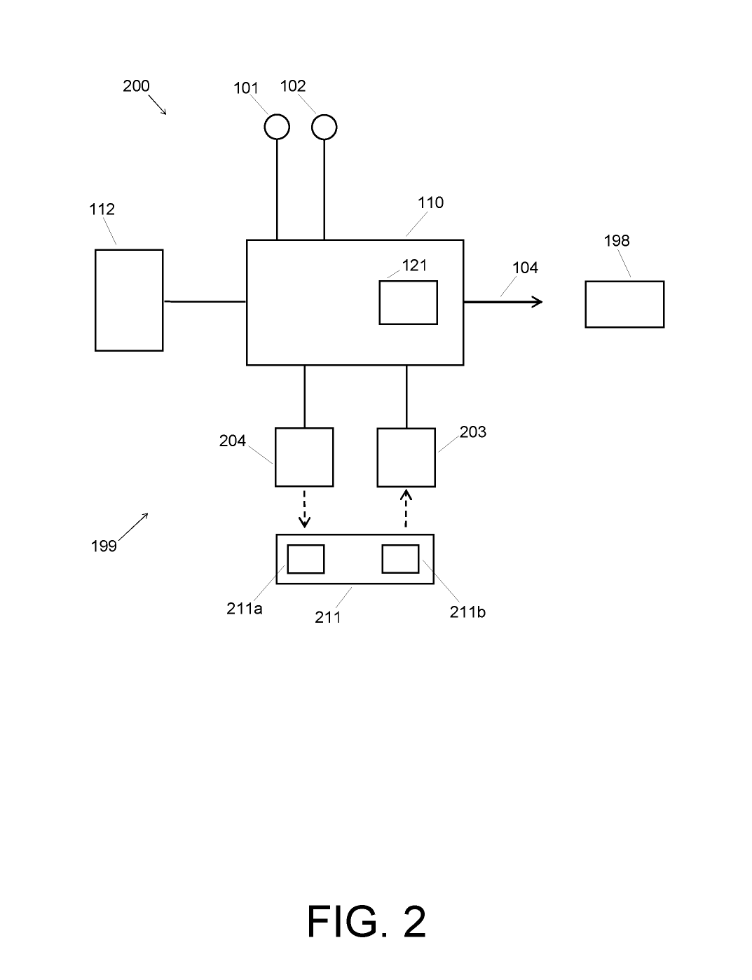

FIG. 2 schematically illustrates an alternative identification sensor 200 which comprises a light transmitter 204, e.g. an infra-red light transmitter, configured to transmit a light signal to the associated wearable ID transmitter 211 in response to generation of a first or second passage signal. The light transmitter 204 may be located near the first passage detector 101, near the second passage detector 102 or between the first and second passage detectors.

Since the light transmitter 204 is activated, i.e. powered, in response to the generation of a passage signal, and since the ID transmitter 211 is configured to only transmit the ID signal when the ID transmitter receives light from the light transmitter 204, the ID receiver 203 only receives an ID signal when an ID transmitter is activated by a light signal. Thereby, the chance that the ID receiver 203 should receive a plurality of ID signals in an interval between generation of the first and second passage signal is lowered in comparison with the situation where wearable ID transmitters continuously transmits ID signals. Consequently, the chance of generation of a false or faulty output signal is lowered.

The light signal from the light transmitter 204 may contain ID information relating to the location of the light transmitter and the wearable ID transmitter 211 may be configured with a light receiver for receiving the ID information in the light signal and a transmitter, e.g. a radio-frequency transmitter, for transmitting both the ID information in the light signal and the wearable ID transmitter's 211 own ID as a wireless signal to the ID receiver 203. The ID information may relate to the room itself, a location in a corridor or other physical locations. The ID information may be an arbitrary number which is uniquely associated with a single physical location. Possibly, the ID information may be transmitted by the identification sensor 200 to a database 112 which will transmit ID data of the physical location back to the identification sensor 200.

By additionally configuring the electronic ID receiver 203 to be able to receive a wirelessly transmitted ID signal from the wearable ID transmitter, where the ID signal additionally contains ID information relating to the location of the light transmitter 204, the identification sensor 200 can be configured so that only the ID signal from the wearable ID transmitter 211 which is receiving light from the light transmitter 204 can cause the generation of an output signal. Thereby, only the ID transmitter 211 carried by a person who has passed the first or second passage sensor 201, 202 can generate an output signal and, therefore, the possibility of generating a faulty output signal is substantially eliminated.

It may happen that that the ID receiver 103 receives an ID signal from another ID transmitter 111, e.g. since such ID transmitters may continuously transmit ID signals. Similarly, for the identification sensor 200 it may happen that the ID receiver 203 receives an ID signal from another ID transmitter 211 being activated by a light signal from another identification sensor. For the identification sensor 100, and the identification sensor 200 wherein the light signal from the light transmitter 204 does not contain ID information, generation of a false output signal may be avoided by configuring the identification sensor 100, 200 with a signal analyzer 121 capable of determining a signal strength of the wirelessly transmitted ID signal. By configuring the identification sensor 100, 200 to accept only ID signals having a strength above a given threshold, or in case multiple ID signals are received, by accepting only the ID signal having the highest strength, generation of false or faulty output signals can be avoided or reduced.

In an embodiment the ID transmitter 211 associated with the identification sensor 200 may be configured to measure the strength of the light signal (e.g. in terms of lux) transmitted by the light transmitter 204. The measured light strength could be added to the transmitted ID signal transmitted by the ID transmitter. In this embodiment, the identification sensor 200 or the ID receiver 203 would be configured to receive light strength data in the transmitted ID signal and to determine which of multiple received strengths are greatest or above a given threshold. Thereby, if multiple ID transmitters 211 receive a light signal after a passage, only the ID signal with the highest strength or strength above a threshold will point out the ID transmitter 211 which is carried by a person who enters or leaves the room.

An identification sensor 100, 200 may be installed for each room or environment having e.g. a lighting installation capable of being controlled by the ambient atmosphere controller 198. Alternatively, parts of the identification sensor 100, 200 may be central parts capable of generating output signals for control of ambient atmospheres of a plurality of rooms or environments. For example, means of the identification sensor 100, 200 such as a processor for determining the order of generation first and second passage signals, the generation of output signals, for determining signal strengths of received signals, activation of the ID receiver 103, 203 to receive ID signals, and e.g. other processing of the received ID signal may contained in a centrally located device capable of handling ID signals from a plurality of ID receivers 103, 203. Parts of the ID receivers 103, 203 such as electronic signal processing parts may also be centrally located in a device, whereas receiver antennas of the ID receivers 103, 203 may be installed for individual rooms. Similarly, the ambient atmosphere controller 198 may be installed for individual rooms, or may be a centrally located device capable of controlling a plurality of ambient systems, e.g. ambient light systems.

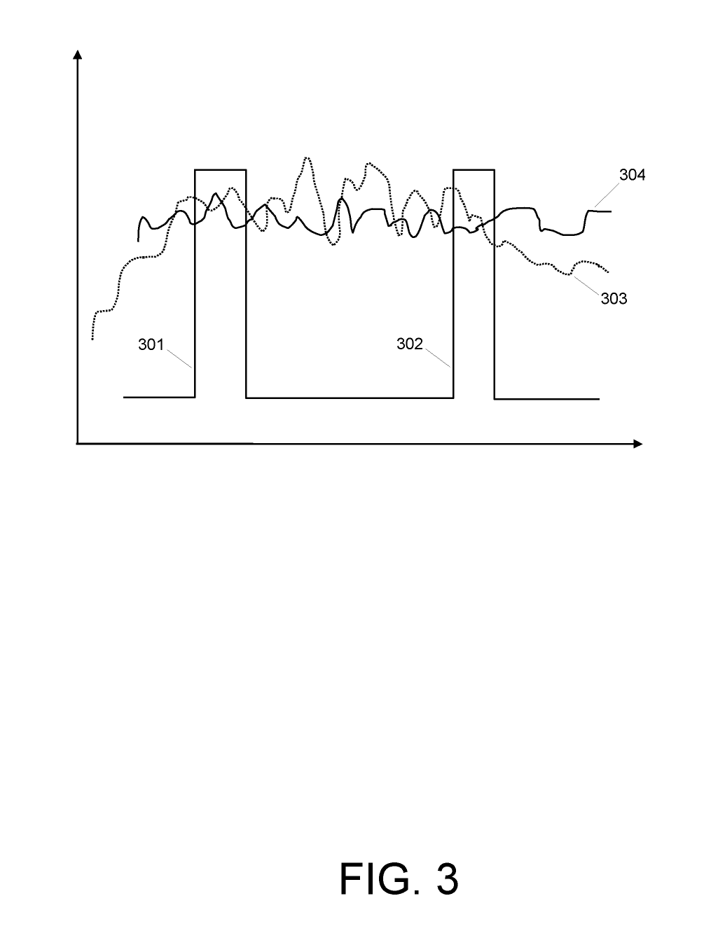

FIG. 3 shows, as a function of time, first and second passage signals 301, 302, a first ID signal 303 from an ID transmitter 111, 211 carried by a person passing the first and second passage sensors 101, 102 (and thereby generating the first and second passage signals 301, 302), and a second ID signal 304 from an ID transmitter carried by a person which does not pass the passage sensors 101, 102, e.g. a patient in a hospital room. By determining the signal strengths of the wirelessly transmitted ID signals 303, 304, e.g. by determining a time-averaged signal strength for a period of time succeeding the first or second passage signals 301, 302 such as the time between the first and second passage signals 301, 302, it is possible to determine which of the determined strengths are largest. The ID transmitter 111, 211 which generated the largest signal strength, e.g. the largest averaged signal strength, can be determined as the ID transmitter 111,211 carried by the person who passed the first and/or second passage sensors 101, 102. Therefore, the ID signal 303 which is seen to have the largest average signal strength for a period of time succeeding the generation of the first passage signal 301 should be used for generating the output signal, i.e. the output signal is generated so that it contains information relating to the ID signal 303 (having the largest signal strength) and the order of generation of the first and second passage signals 301, 302.

The identification sensor may be configured to activate, e.g. powering, the electronic ID receiver 103, 203 in response to generation of the first or second passage signals 301, 302. Thus, the generation of the first ID signal 301 in FIG. 3 could activate the ID receiver 103, 203. Thus, it may be avoided that the ID receiver 103,203 consumes unnecessary power. For the identification sensor 200, also the light transmitter 204 could be activated, e.g. powered, in response to generation of the first or second passage signals 301, 302, to avoid unnecessary consummation of power.

An aspect of the invention also relates to a room controller 199 which in addition to identification sensor 100, 200 also comprises the ambient atmosphere controller 198 being controllable via the output signal from the identification sensor 100, 200.

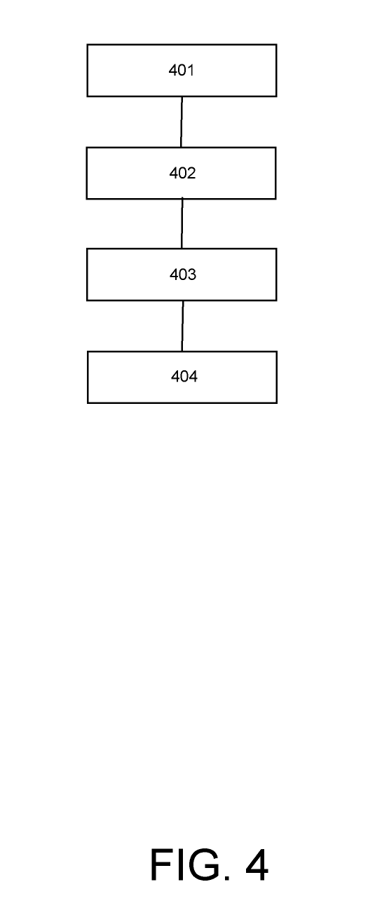

FIG. 4 illustrates process steps 401-405 of an embodiment of a method of the invention which comprises:

Step 401 for generating, by use of a first passage detector 101, a first passage signal 301 in response to passage of the person at a first location of the gate,

Step 402 for generating, by use of a second passage detector 102, a second passage signal 302 in response to passage of the person at a second location of the gate,

Step 403 for detecting the order of generation of the first and second passage signals 301, 302, and

Step 404 for generating an output signal containing information relating to the order of generation of the first and second passage signals.

An additional step may comprise a step for receiving, by use of an ID receiver 103, 203, a wirelessly transmitted ID signal 303, 304 from an associated wearable ID transmitter 111, 211. Furthermore, the output signal may be generated so that it contains information relating both to the ID signal 303, 304 and the order of generation of the first and second passage signals.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

1. A room controller comprising an ambient atmosphere controller for controlling the ambience of a room and an identification sensor for gate identification of a person, said identification sensor comprising:
a first passage detector for generating a first passage signal in response to passage of the person at a first location associated with the gate,
a second passage detector for generating a second passage signal in response to passage of the person at a second location associated with the gate,
an ID receiver for receiving a wirelessly transmitted ID signal from an associated wearable ID transmitter, wherein the ID signal contains information relating to the identity of the person wearing the wearable ID transmitter,
wherein the identification sensor is configured to detect the order of generation of the first and second passage signals, and wherein the identification sensor is further configured to generate an output signal containing information relating to the order of generation of the first and second passage signals in response to receipt of the wirelessly transmitted ID signal for use by the ambient atmosphere controller (198) for controlling the ambience of a room.

2. (canceled)

3. A room controller according to claim 1, wherein the identification sensor is furthermore configured to generate an output signal containing information relating to the ID signal received by an ID receiver.

4. A room controller according to claim 1, wherein the identification sensor is configured to determine a signal strength of the wirelessly transmitted ID signal.

5. A room controller according to claim 4, wherein the identification sensor is configured to determine the signal strength in dependence of the first or second passage signals.

6. A room controller according to claim 1, wherein the identification sensor is configured to activate the ID receiver to receive ID signals in dependence of the first or second passage signals.

7. A room controller according to claim 1, wherein the identification sensor further comprising:
a light transmitter configured to transmit a light signal to the associated wearable ID transmitter, where the ID transmitter is configured with a light receiver for receiving the light signal and where the ID transmitter is further configured to transmit the ID signal in dependence of receipt of the light signal.

8. A room controller according to claim 7, wherein the light transmitter is furthermore configured to transmit a light signal comprising ID information, and wherein the ID transmitter is furthermore configured to transmit the ID signal containing the ID information received and the ID information stored in the ID transmitter.

9. A room controller according to claim 7, wherein the identification sensor is configured to activate the light transmitter to transmit the light signal to the wearable ID transmitter in dependence of the first or second passage signals.

10. A room controller according to claim 1, wherein the identification sensor is configured to transmit data relating to the ID signal to a database and to receive ID data from the database in response to the data transmitted to the database, and where the identification sensor is configured to generate the output signal so that is contains information relating to the ID data received from the database.

11. (canceled)

12. A method for controlling the ambience of a room, comprising:
generating, by use of a first passage detector, a first passage signal in response to passage of the person at a first location of the gate,
generating, by use of a second passage detector, a second passage signal in response to passage of the person at a second location of the gate,
detecting the order of generation of the first and second passage signals,
receiving a wirelessly transmitted ID signal from an associated wearable ID transmitter, wherein the ID signal contains information relating to the identity of the person wearing the wearable ID transmitter,
generating an output signal containing information relating to the order of generation of the first and second passage signals in response to receipt of the wirelessly transmitted ID signal, and
controlling the ambience of the room by use of the output signal.
